(19) United States
(12) Patent Application Publication
(10) Pub. No.: US 2024/0411491 A1
(43) Pub. Date: Dec. 12, 2024

(54) CONTROL APPARATUS, METHOD OF CONTROLLING IMAGE PROCESSING APPARATUS, AND STORAGE MEDIUM

(71) Applicant: CANON KABUSHIKI KAISHA, Tokyo (JP)

(72) Inventor: KAZUKI KADO, Kanagawa (JP)

(21) Appl. No.: 18/734,316

(22) Filed: Jun. 5, 2024

(30) Foreign Application Priority Data
Jun. 7, 2023 (JP) 2023-093891

(51) Int. Cl. G06F 3/12; H04N 1/00

(52) U.S. Cl. CPC G06F 3/1256; H04N 1/00411; H04N 1/00474

(57) ABSTRACT

A control apparatus according to the present disclosure includes: one or more memories; and one or more processors functioning by executing instructions stored in the one or more memories as the following units: an acceptance unit configured to accept a length from an end of a sheet to a first folding position; and a first setting unit configured to set a second folding position different from the first folding position on the sheet based on a length of the sheet and the length accepted by the acceptance unit.

### BACKGROUND OF THE INVENTION

### Field of the Invention

The present disclosure relates to a control apparatus, a method of controlling an image processing apparatus, and a storage medium.

### Description of the Related Art

Image forming apparatuses are equipped with finishing functions to perform various types of processes such as sorting, stapling, folding, and punching on printed output sheets. For example, a function called C-fold makes a valley fold on a sheet of a size having long sides X and short sides Y at each of two folding positions that substantially equally divide each long side X into three parts. As a result, the printed sheet is folded and discharged in a square U-shape with each long side reduced to approximately ⅓ of its length. For example, an A4 sheet can be enclosed in an envelope of Nagagata 3 (120×235 mm) or Yougata 4 (235×105 mm).

In a case where a folding position needs to be adjusted, the user opens a setting screen for adjusting the folding positions and makes a subtle adjustment based on a preset folding position. Incidentally, a technique to adjust the folding positions of a sheet according to its envelope size has been proposed.

Japanese Patent Laid-Open No. 2015-205763 discloses a technique that adjusts the folding positions on a sheet in a case where its envelope is a window envelope such that the length, in the conveyance direction, of the surface of the sheet on which specific information such as an address and a name is printed is appropriately within the length of the windowed surface of the envelope in the conveyance direction. In this way, the sheet can be enclosed in the envelope so as not to move inside it. Moreover, the specific information such as an address and a name will be visually recognizable through the window portion of the envelope without fail.

As mentioned above, in the case of adjusting a folding position in the conventional manner, the user needs to set an adjusted value based on a preset folding position. Here, in a case where there are multiple folding positions as with C-fold, it is difficult for the user to intuitively figure out which part's value corresponds to the adjusted value to be set. Also, the technique does not support finishing for envelopes of non-standard sizes and folding for non-envelope applications. Thus, the user cannot freely set the fold widths.

An object of the present disclosure is to improve usability in setting folding positions.

### SUMMARY OF THE INVENTION

A control apparatus according to the present disclosure includes: one or more memories; and one or more processors functioning by executing instructions stored in the one or more memories as the following units: an acceptance unit configured to accept a length from an end of a sheet to a first folding position; and a first setting unit configured to set a second folding position different from the first folding position on the sheet based on a length of the sheet and the length accepted by the acceptance unit.

Further features of the present invention will become apparent from the following description of exemplary embodiments with reference to the attached drawings.

### BRIEF DESCRIPTION OF THE DRAWINGS

FIG. 1 is a block diagram illustrating a hardware configuration of a multi-function peripheral (MFP);

FIG. 2A is a diagram illustrating an internal configuration of the MFP;

FIG. 2B is a diagram illustrating a first folding operation for C-fold;

FIG. 2C is a diagram illustrating a second folding operation for C-fold;

FIG. 3 is a diagram illustrating an example of a finishing screen;

FIG. 4 is a block diagram illustrating a functional configuration of the MFP;

FIG. 5 is a flowchart illustrating a flow of a folding position setting process;

FIGS. 6A and 6B are diagrams illustrating an example of an advanced C-fold setting screen;

FIGS. 7A to 7C are diagrams explaining sheet sizes and folding positions;

FIG. 8 is a diagram illustrating an example of an acceptance screen;

FIG. 9 is a diagram illustrating an example of a sheet selection screen;

FIG. 10 is a diagram illustrating an example of an error screen;

FIG. 11 is a diagram illustrating an example of a fold width confirmation screen;

FIG. 12 is a diagram illustrating an example of a copy screen; and

FIG. 13 is a diagram illustrating an example of an error screen.

### DESCRIPTION OF THE EMBODIMENTS

An embodiment of the present disclosure will be described in detail below with reference to the drawings. The configurations described in the following embodiment are mere examples. The configurations described in the embodiment do not limit the scope of the present disclosure.

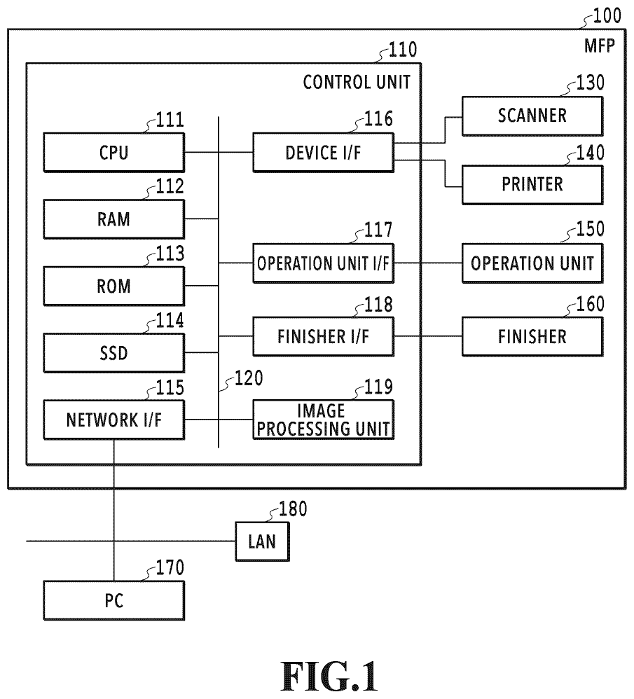

FIG. 1 is a block diagram illustrating a hardware configuration of an MFP 100 representing an example of an image processing apparatus according to the present embodiment.

As illustrated in FIG. 1, the MFP 100 has a control unit 110, a scanner 130, a printer 140, an operation unit 150, and a finisher 160. The MFP 100 is connected to a personal computer (PC) 170 through a network such as a local area network (LAN) 180. The MFP 100 has a printing function, a copy function, a sending function, finishing functions, and so on. The MFP 100 may be communicatively connected to an information terminal having a communication function, such as a server apparatus, a smartphone, or a tablet terminal, instead of the PC 170. The MFP 100 may be connected to multiple PCs 170.

The printing function is a function of analyzing page description language (PDL) data received from the PC 170 and performing printing on a sheet-shaped medium, such as paper, (hereinafter referred to as “sheet”) with the printer 140. The copy function is a function of performing printing on a sheet by using image data loaded by scanning a document with the scanner 130. The sending function is a function of sending image data loaded by scanning a document to the PC 170 through the network. The finishing functions are functions of performing post-processing such as a folding process, a stapling process, and a punching process on a sheet(s) printed by the printing function with the finisher 160.

The control unit 110 has a central processing unit (CPU) 111, a random-access memory (RAM) 112, a read-only memory (ROM) 113, a solid state drive (SSD) 114, and an internal bus 120 connecting these to one another. To the internal bus 120 are connected a network interface (I/F) 115, a device I/F 116, an operation unit I/F 117, a finisher I/F 118, and an image processing unit 119, which are incorporated in the control unit 110.

The CPU 111 loads programs stored in the ROM 113 to the RAM 112 and execute them. In this way, the CPU 111 functions as a control unit that executes the multiple functions of the MFP 100, for example, the copy function and the post-processing functions. The CPU 111 executes various processes for scan jobs, print jobs, copy jobs, finishing jobs, and so on based on operations input by the user through the operation unit 150 or the PC 170. At this time, the CPU 111 stores image data, setting values, and so on related to the jobs in the RAM 112 or the SSD 114 as appropriate.

The RAM 112 includes a non-volatile memory in which contents stored therein can be held, like a ferroelectric RAM (FRAM) (registered trademark) or the like, and a volatile memory in which contents stored therein are erased after the power is turned off, like a dynamic RAM (DRAM) or the like. The RAM 112 includes a work area which temporarily holds programs loaded from the ROM 113 or the like and is used by the CPU 111 to perform the various processes to be described later. The RAM 112 temporarily stores various received data in its volatile memory and stores various setting data in its non-volatile memory.

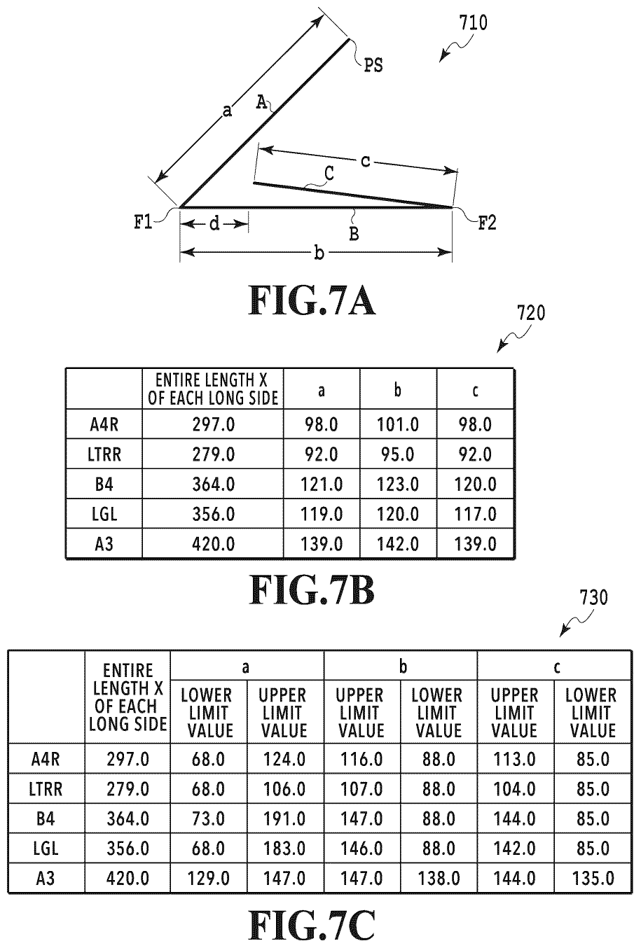

For example, information on selectable sheets and information on folding positions, binding positions, punching positions, and so on are stored in advance for each finishing process in the RAM 112 as setting data. Tables 720 and 730 illustrated respectively in FIGS. 7B and 7C to be mentioned later are stored in the non-volatile memory of the RAM 112 as well.

The ROM 113 has a read-only non-volatile storage area and a rewritable storage area, such as a flash ROM. The non-volatile storage area permanently holds a boot program for the MFP 100, programs and data for its basic input/output system (BIOS), and the like. The ROM 113 also stores programs to be executed by the CPU 111 or the image processing unit 119 and various programs for causing the MFP 100 to operate.

The SSD 114 is a storage device that stores image data and the like related to various jobs. Note that the SSD 114 is illustrated as the storage device in FIG. 1, but the storage device is not limited to the SSD 114 as long as it has a storage area with a large capacity. For example, a configuration including a hard disk drive (HDD) in place of the SSD 114 may be employed.

The operation unit I/F 117 is an interface connected to the operation unit 150. The operation unit 150 has hardware keys and a touch panel for accepting input of various settings and instructions addressed to the MFP 100, and a display for displaying processing states. The hardware keys include a copy button, a cancel button, a reset button, a numeric keypad, and the like. The display is a liquid crystal display, an organic light-emitting diode display, or the like.

The operation unit I/F 117 sends setting information, execution instructions, and the like input via the user's operations on the touch panel, the hardware keys, and the like of the operation unit 150 to the CPU 111. The CPU 111 sends display data to be displayed on the operation unit 150 to the operation unit 150 through the operation unit I/F 117 and causes the operation unit 150 to display the data on its display. The CPU 111 causes the operation unit 150 to display a finishing screen 300, an advanced C-fold setting screen 600, an acceptance screen 800, a sheet selection screen 900, a fold width confirmation screen 1100, a copy screen 1200, error screens 1000 and 1300, and so on.

Incidentally, an operation unit (a display unit, an input unit, etc.) of the PC 170 connected to the MFP 100 through the network I/F 115 may be utilized similarly to how the operation unit 150 is utilized. For example, the CPU 111 of the MFP 100 causes the display unit of the PC 170 connected thereto through the network I/F 115 to display information output from the CPU 111. Also, the CPU 111 of the MFP 100 may be configured to obtain instructions input on the input unit of the PC 170 by the user.

The network I/F 115 is a communication control circuit, a communication port, and the like for communicatively connecting to the computer (PC) 170 through a network such as the LAN 180, a wide area network (WAN), or the Internet. The CPU 111 sends and receives data to be printed (such as PDL data) to and from the PC 170 through the network I/F 115. In this way, the user can remotely use the MFP 100 with the PC 170. The communication connection can be wired or wireless.

The image processing unit 119 is a processor that executes image processing, and executes various types of image processing on image data. The image processing unit 119 performs image processing such as, for example, a process of translating (converting) print data to be handled in the MFP 100 (e.g., PDL data) into image data (bitmap image data), a color space conversion process, and a CMYK conversion process, and the like.

The device I/F 116 is an interface that connects the CPU 111 to the scanner 130 and the printer 140. The device I/F 116 executes a synchronous/asynchronous conversion process on image data. In a case of performing the conversion process, the device I/F 116 outputs image data generated by the scanner 130 to the internal bus 120. Also, the device I/F 116 obtains image data for printing through the internal bus 120 and outputs it to the printer 140.

The scanner 130 performs a scanning operation in accordance with a control signal input from the CPU 111. Specifically, the scanner 130 reads a document to be scanned with an optical element, such as a charge-coupled device (CCD), and generates digital image data. The generated image data is sent to the CPU 111 through the device I/F 116 and stored in the RAM 112 or the SSD 114.

The printer 140 performs a printing operation in accordance with a control signal input from the CPU 111. Specifically, the printer 140 prints an image on a sheet based on image data for printing input from the image processing unit 119 or the CPU 111. The sheet is fed from one of sheet cassettes 217 or a manual feed tray 218.

Note that the printing method of the printer 140 may be any method. For example, the printer 140 may be a laser beam printer that uses toners as color materials to form an image on a sheet by electrophotography and outputs the sheet, or an ink jet printer that uses inks as color materials. The printer 140 may form images by another method. The sheet after the printing by the printer 140 passes through a sheet conveyance path inside the printer 140 and is discharged from a sheet discharge port 223 and conveyed into the finisher 160.

The finisher I/F 118 is an interface that connects the CPU 111 to the finisher 160. The finisher 160 is connected as an apparatus downstream of the printer 140. The finisher 160 is instructed to execute post-processing by the CPU 111 through the finisher I/F 118.

The finisher 160 executes the post-processing on a printed sheet in accordance with a control signal input from the CPU 111. The post-processing includes a folding process, such as C-fold, a sorting process, a grouping process, a stapling process, a shifting process, a punching process, and so on and may be processing combining two or more of these processes.

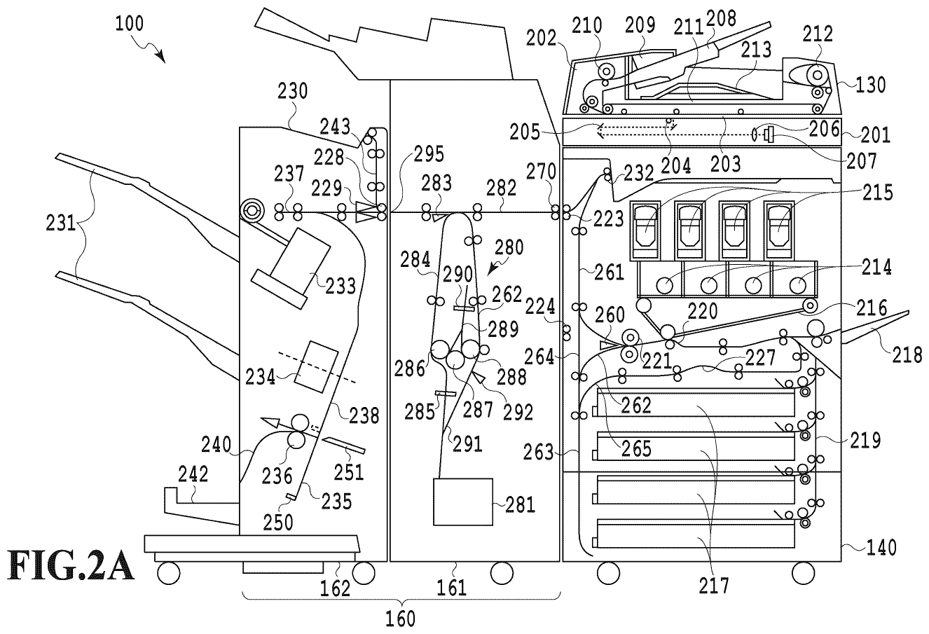

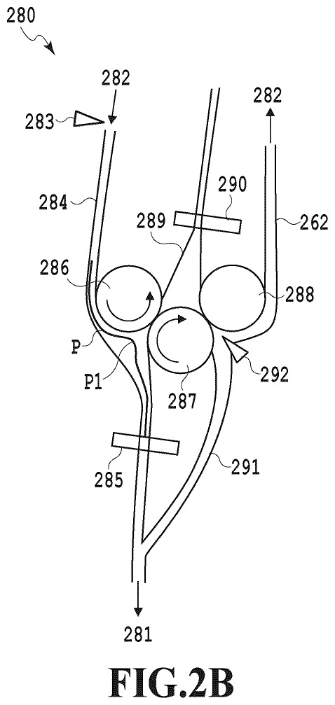

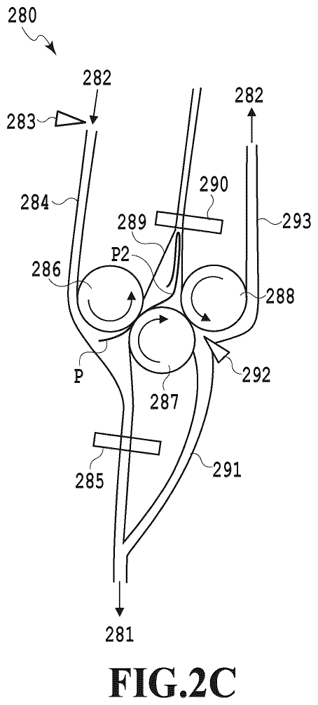

FIG. 2A is a diagram illustrating an internal configuration of the MFP 100. As illustrated in FIG. 2A, the MFP 100 includes the scanner 130, the printer 140, and the finisher 160. The finisher 160 includes a CZ-folding unit 161 and a finishing unit 162.

The scanner 130 includes a reader 201 and a document feeder (DF) 202. The reader 201 irradiates a document on a clear platen glass 203 with light from a light source 204. The light reflected by the document is guided to a CCD 207 by reflection plates 205 and a lens 206. Then, the light reflected by the document is converted into a digital signal by the CCD 207, which is then subjected to desired image processing to be converted into print image data. The print image data is stored in the SSD 114 of the control unit 110.

The DF 202 has a document setting unit 208 to place a document. The document setting unit 208 is provided with a document presence sensor 209 which detects a document set on the document setting unit 208.

In a case where the scanner 130 receives a reading start instruction from the user, a document feed roller 210 and a conveyance belt 211 rotate, thereby feeding the document set on the document setting unit 208. The document thus fed is conveyed to a predetermined position on the platen glass 203. Then, the image on the document is read by the method described above, and the resulting image data is stored in the SSD 114. After the reading, the conveyance belt 211 rotates again, thereby conveying the document. The document is discharged onto a document discharge tray 213 by way of a conveyance roller 212.

There may be multiple documents. In this case, when a document is conveyed from the platen glass 203, the next document is simultaneously fed by the feed roller 210 and is successively read.

The printer 140 is an apparatus that prints the print image data stored in the SSD 114, and incorporates an image forming unit. Photosensitive members 214 of colors of yellow, magenta, cyan, and black are exposed to light based on the print image data, so that electrostatic latent images are formed on the photosensitive members 214. Then, toner development is performed with toners supplied from toner cartridges 215, and the images thus visualized undergo primary transfer onto an intermediate transfer belt 216.

The intermediate transfer belt 216 rotate clockwise. At a secondary transfer position 220, the images are transferred from the intermediate transfer belt 216 onto a sheet fed through the sheet feed conveyance path 219 from one of the sheet cassettes 217 or the manual feed tray 218.

The sheet to which the images have been transferred has the toners fixed with pressure and heat at a fixing unit 221, is conveyed to a sheet discharge conveyance path 261, and then discharged from a center tray sheet discharge port 232 or a side tray sheet discharge port 224. Here, the side tray sheet discharge port 224 is a sheet discharge port from which sheets can be discharged only in a case where the finisher 160 is not mounted.

In a case of performing post-processing on the sheet on which the images have been formed with the finisher 160, the sheet undergoes a switchback operation at the center tray sheet discharge port 232 and is conveyed to the sheet discharge port 223 leading to the finisher 160. In a case of double-side printing, the sheet is guided to a branching path 262 by a flapper 260 after passing the fixing unit 221, undergoes a switchback operation at a reverse path 263, and is conveyed to the secondary transfer position 220 again by way of a branching path 265 and a double-side printing sheet conveyance path 227. By the switchback operation at the reverse path 263, the sheet is turned over.

In a case of turning over a sheet and then feeding it to the finisher 160, the sheet is guided to the branching path 262 by the flapper 260 after passing the fixing unit 221 and is conveyed to the reverse path 263. Then, the sheet undergoes a switchback operation and is guided to the center tray sheet discharge port 232 through a conveyance path 264 and the conveyance path 261. At the center tray sheet discharge port 232, the sheet undergoes a switchback operation and is conveyed to the sheet discharge port 223 leading to the finisher 160.

The finisher 160 performs post-processing corresponding to a finishing function designated by the user on the printed sheet. The printed sheet conveyed from the sheet discharge port 223 leading to the finisher 160 is conveyed into the finisher 160 (CZ-folding unit 161) from a sheet feed port 270. The sheet having passed through the sheet feed port 270 passes through a conveyance path 282 and is conveyed to a conveyance path 284 or a discharge port 295 by means of a flapper 283 according to its setting.

In the case where the sheet is conveyed to the discharge port 295, it will be conveyed to the finishing unit 162. In the case where the sheet is conveyed to the conveyance path 284, it will be conveyed to a CZ-folding process unit 280.

The CZ-folding unit 161 includes the sheet feed port 270, the CZ-folding process unit 280, and a C-folded sheet discharge port 281.

The CZ-folding process unit 280 is capable of performing the following three types of processes on a sheet sent from the printer 140.
1. Passage mode
2. C-folding mode
3. Z-folding mode

Among these, the “passage mode” is a process of sending the sheet to the subsequent unit (finishing unit 162) without performing a C-folding process or a Z-folding process. After passing through the conveyance path 282, the sheet is sent to a sheet feed port 228 of the finishing unit 162 by means of the flapper 283 through the discharge port 295.

The “C-folding mode” of the CZ-folding process unit 280 will be described using FIGS. 2B and 2C. FIGS. 2B and 2C are diagrams illustrating details of the CZ-folding process unit 280. C-fold refers to a process of valley-folding (or mountain-folding) a sheet(s) at each of two folding positions that are parallel to each other.

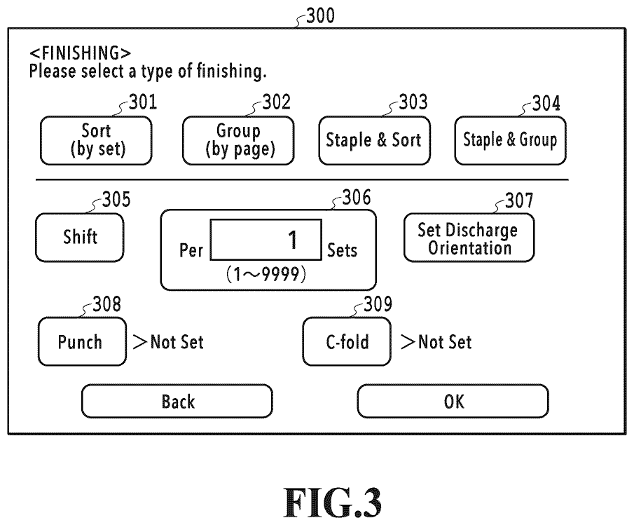

In the “C-folding mode”, a sheet P conveyed from the conveyance path 282 to the CZ-folding process unit 280 is subjected to a process in which the sheet P is folded by a folding method called “C-fold” or “inside tri-fold”, and then discharged to the C-folded sheet discharge port 281. In a case where “C-fold” is designated on the finishing screen 300 in FIG. 3, the flapper 283 operates so as to guide the sheet P from the conveyance path 282 to the conveyance path 284, as illustrated in FIG. 2B. The sheet P is conveyed to a position at which its leading end contacts a stopper 285. In a case of performing a process of folding multiple sheets P in an overlapping manner, a standby state continues until the given number of sheets P to be folded in an overlapping manner are conveyed to the stopper 285 and form a stack of sheets including the given number of sheets to be folded in an overlapping manner.

When the leading end of the sheet P comes into contact with the stopper 285, a bent portion P1 is formed on the sheet P and nipped between folding rollers 286 and 287. As a result, the sheet P is folded for the first time. The position of the stopper 285 is adjusted such that the sheet length from the nipping position between the folding rollers 286 and 287 is the sum (a+b) of the fold width (a) of a panel A and the fold width (b) of a panel B in FIG. 7A.

The sheet P folded once is guided to a conveyance path 289. A folding position F2 on the sheet P comes into contact with a stopper 290, and a bent portion P2 is formed on the sheet. Thereafter, the bent portion P2 is nipped between the folding roller 287 and a folding roller 288 (FIG. 2C).

As a result, the sheet P is folded for the second time. The position of the stopper 290 is adjusted such that the sheet length from the nipping position between the folding rollers 287 and 288 is the fold width b of the panel B in FIG. 7A. The sheet P thus folded twice is discharged to the C-folded sheet discharge port 281 through a conveyance path 291 by means of a flapper 292.

In the “Z-folding mode”, the stopper 285 is disposed at such a position that the sheet length from the stopper 285 to the nipping position between the folding rollers 286 and 287 is ¼ of the entire length of the sheet P. The sheet P folded once is guided to the conveyance path 289. When the sheet P comes into contact with the stopper 290, a bent portion is formed on the sheet P, which is then nipped between the folding rollers 287 and 288. As a result, the sheet P is folded twice. Here, the stopper 290 is positioned such that the sheet length from the first folding position to the bent portion is ¼ of the sheet P. The sheet thus folded twice is returned to the conveyance path 282 through a conveyance path 293 by means of the flapper 292. Thereafter, the flapper 283 operates such that the sheet is guided to the sheet discharge port 295 and sent to the finishing unit 162.

The finishing unit 162 includes a sample tray 230, a stack tray 231, and a booklet tray 242 and is capable of performing suitable processes, such as stapling, sorting, shifting, and bookbinding, and discharging the resulting product.

In a case of outputting a sheet onto the sample tray 230, a flapper 229 operates such that the sheet coming into the sheet feed port 228 passes through a conveyance path 243 and is discharged onto the sample tray 230.

In a case of outputting a sheet onto the stack tray 231, the flapper 229 operates such that the sheet coming into the sheet feed port 228 is guided to a conveyance path 237 and discharged onto the stack tray 231. The stack tray 231 is vertically movable. In a case of discharging a sheet onto the stack tray 231 at a lower position, the stack tray 231 at the lower position moves up. In the case of discharging a sheet onto the stack tray 231, it is also possible to perform a sorting process or a shifting process with an intermediate tray 244, a stapling process with a stapler 233, and the like.

In a case of discharging sheets onto the booklet tray 242, the flapper 229 operates such that each sheet coming into the sheet feed port 228 is guided to the conveyance path 237, undergoes a switchback operation, and is conveyed to a stacking unit 235. In a case of binding sheets by saddle stitching, a binding process is performed with a stapler 234 at the position of an intermediate tray 238, and the saddle-stitched stack of sheets is conveyed to the stacking unit 235. Here, a positioning member 250, a pushing member 251, and a roller pair 236 are provided. By projecting the pushing member 251 toward the stack of sheets stacked on the stacking unit 235, the stack of sheets is pushed into the middle of the roller pair 236 to be folded. The folded sheets are discharged onto the booklet tray 242 through a conveyance path 240.

The positioning member 250 is capable of moving up and down along the stacking unit 235. In the folding operation, the positioning member 250 is moved such that the folding position on the stack of sheets conveyed to the stacking unit 235 faces the folding rollers 236.

Incidentally, the CPU 111 of the MFP 100 controls the positions at which the stoppers 285 and 290 of the CZ-folding unit 161 and the positioning member 250 of the finishing unit 162 are stopped (the amounts of movement of the stoppers 285 and 290 and the positioning member 250). The CPU 111 moves the positions of the stoppers 285 and 290 and the positioning member 250 by controlling driving motors provided individually for the stoppers 285 and 290 and the positioning member 250.

FIG. 3 is a diagram illustrating an example of the finishing screen 300 displayed on the operation unit 150. On the finishing screen 300, finishing processes such as sorting, grouping, stapling, folding, shifting, and punching can be configured. In response to the user's operation on a button, that button is selected. By operating the “OK” button in this state, the screen transitions to an advanced setting screen for the selected finishing process.

A sorting button 301 is a button to be operated in a case of collating (sorting) sheets by page for each set. A grouping button 302 is a button to be operated in a case of collectively discharging multiple sheets per page. A stapling & sorting button 303 is a button to be operated in a case of combining a stapling process with the sorting process. A stapling & grouping button 304 is a button to be operated in a case of combining a stapling process with the grouping process. Each of these processes (buttons 301 to 304) is exclusive and cannot be selected with the others at the same time. Each button will appear unselectable in a case where it cannot be combined with the other processes.

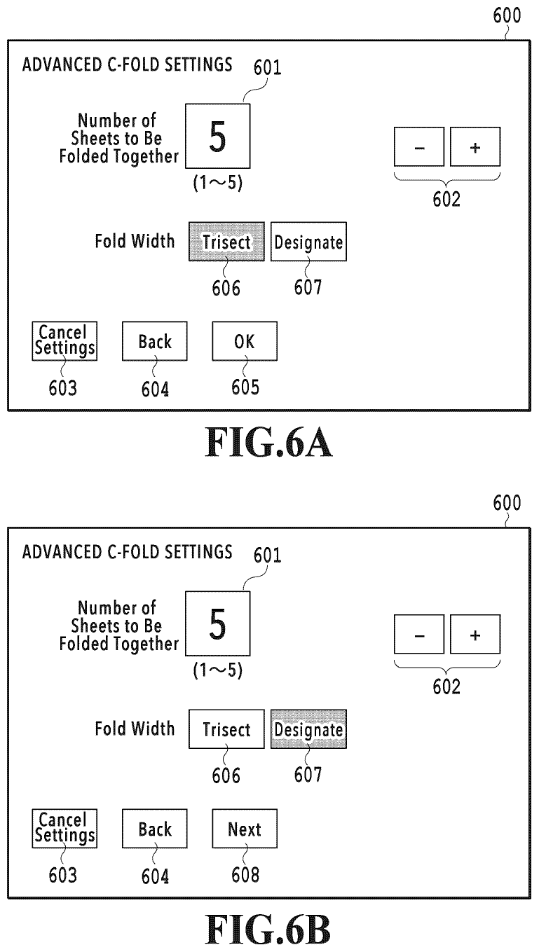

A shifting button 305 is a button to be operated in a case of shifting the sheets by stack. By inputting a numerical value into a numerical value input area 306, sheets will be shifted at intervals of the designated number of stacks. In response to operating a sheet discharge orientation designation button 307, the screen transitions to a screen for designating whether to discharge the sheet(s) with its (their) front face(s) up or down. A punching button 308 is a button to be operated in a case of punching the sheet(s). In response to operating a C-fold button 309, the screen transitions to the advanced C-fold setting screen 600 to be described later (FIG. 6).

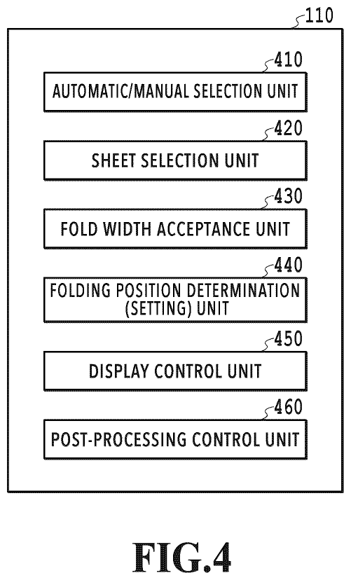

Next, a functional configuration of the MFP 100 in the present embodiment will be described with reference to FIG. 4.

FIG. 4 is a block diagram illustrating the functional configuration of the MFP 100. Note that the functional configuration in FIG. 4 may be implemented as the configuration of the modules in a program related to folding process settings. The program is stored in the SSD 114 or the ROM 113, and the CPU 111 implements the functions in FIG. 4 by loading the program from the SSD 114 or the ROM 113 and executing it.

As illustrated in FIG. 4, the MFP 100 in the present embodiment has an automatic/manual selection unit 410, a sheet selection unit 420, a fold width acceptance unit 430, a folding position determination (setting) unit 440, a display control unit 450, a post-processing control unit 460, and so on.

The automatic/manual selection unit 410 accepts selection of automatic setting with which the folding positions in a folding process are preset positions or manual setting with which the folding positions are any positions set by the user. The automatic/manual selection unit 410 displays the advanced setting screen 600 such as the one illustrated in FIGS. 6A and 6B to accept the user's selection of the automatic setting (equally dividing the sheet(s) into three parts) or the manual setting (designating the folding positions). The advanced setting screen 600 accepts selection of the number of sheets to be folded in an overlapping manner as well as the selection of automatic or manual setting of the fold widths.

The folding positions in the automatic setting are, for example, two preset folding positions defined by substantially equally dividing the sheet(s) into three parts in a case of a tri-folding process called C-fold. This is a common folding process used to enclose a sheet(s) in an envelope. With the manual setting, the user can input fold widths. With the manual setting, in response to the user setting the fold width (a) being the length from one end PS of the sheet(s) to the first folding position (F1 in FIG. 7A), the CPU 111 determines the fold widths (b, c) of the other panels in the C-fold. As a result, the second folding position on the sheet(s) (F2 in FIG. 7A) is set. A method of determining the fold widths (b, c) will be described later.

The sheet selection unit 420 accepts selection of the sheet(s) to be subjected to the folding process. For example, sheet sizes such as A4, A4R, B4, LTRR, LGL, and A3 are selectable. The selectable sheet sizes vary by the type of the finishing function(s) and the sheets accommodated in the sheet cassettes 217 of the MFP 100. For example, A4R, A3, and the manual feed tray 218 are selectable in a case of performing C-fold with the MFP 100 in the present embodiment.

The fold width acceptance unit 430 accepts input of the fold width (a) from the user in the case where the manual setting is selected through the automatic/manual selection unit 410. The fold width acceptance unit 430 displays the fold width acceptance screen 800 on the operation unit 150. On the acceptance screen 800, the fold width acceptance unit 430 accepts input of the fold width (a) being the length from an end of the sheet(s) to the first folding position. Details of the acceptance screen 800 will be described later.

In the case where the automatic setting is selected through the automatic/manual selection unit 410, the folding position determination (setting) unit 440 sets the preset folding positions as the first and second folding positions F1 and F2 based on the selected sheet size. The preset folding positions are determined based on the fold widths (a, b, c) in the table 720 (FIG. 7B). The table 720 will be described later.

As illustrated in FIG. 7A, the fold widths (a, b, c) are the lengths of the panel A, the panel B, and a panel C formed by C-fold in the sheet conveyance direction. The length from the one end PS of the sheet to the folding position F1 is the fold width (a) of the panel A. The position separated from the one end PS of the sheet by a length equal to the sum of the fold widths of the panels A and B (a+b) is the folding position F2.

In the case where the manual setting is selected through the automatic/manual selection unit 410, the folding position determination (setting) unit 440 determines the fold widths (b, c) of the panels B and C based on the input fold width (a) of the panel A and the size of each long side of the selected sheet. As a result, the folding positions F1 and F2 are set.

Specifically, the folding position determination (setting) unit 440 determines the fold widths (a, b, c) of the panels A, B, and C from Equations (1) below.

Incidentally, it is desirable that the CPU 111 determines the folding position F2 with a constraint value (margin) d of about 3 [mm] taken into account. In the present embodiment, a margin d is provided in the center panel B of the C-fold. In the following equation, I represents an input value, and X represents the length of each long side of the sheet(s).

$$\begin{matrix}a = I \\ b = ( X - a ) / 2 + d \\ c = X - a - b\end{matrix}$$

The constraint value (margin) d is determined based on the folding mechanism of the finisher 160 and the sheet type (including the thickness, the material, etc.). The margin d may be determined according to the number of sheets to be folded in an overlapping manner or the like.

For example, for the CZ-folding process unit 280 illustrated in FIGS. 2A to 2C, the stoppers 285 and 290 and the rollers 286, 287, and 288 as well as the positional relationship between the sheet conveyance paths in the CZ-folding process unit 280, their sizes, and the like are taken into account. It is preferable that the margin d be set to be greater than a predetermined reference value in a case where the thickness of the sheet(s) is greater than a predetermined thickness and/or the number of sheets to be folded in an overlapping manner is greater than a predetermined number. The value of the margin d may be determined based on the sheet material. The margin d may be determined based on a combination of two or more of the structure of the folding mechanism, the sheet thickness, the sheet material, and the number of sheets to be folded in an overlapping manner.

In the case where the manual setting is selected through the automatic/manual selection unit 410, the folding position determination (setting) unit 440 refers to the table 730 (FIG. 7C) and determines the folding positions such that the fold widths of all panels fall within the respective ranges set in the table 730. The table 730 defines the ranges (an upper limit value and a lower limit value) of the fold widths of panels formed on sheets by a folding process. Details of the table 730 and how to set the folding positions will be described later.

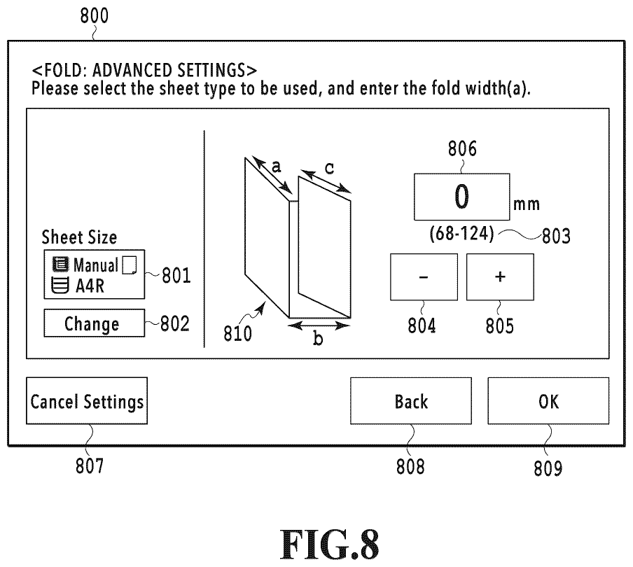

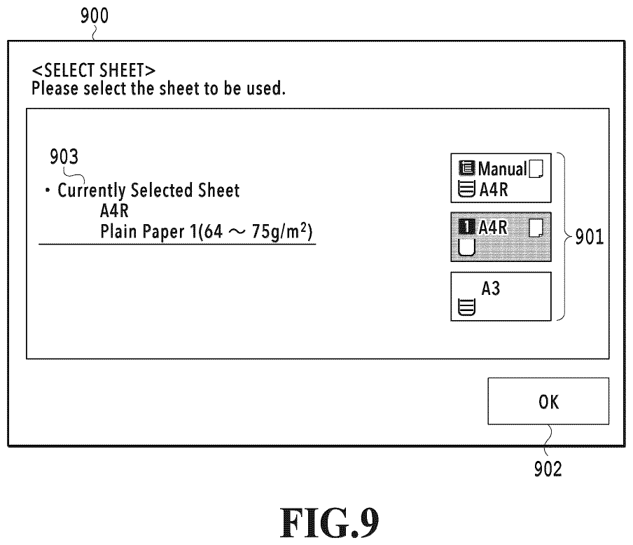

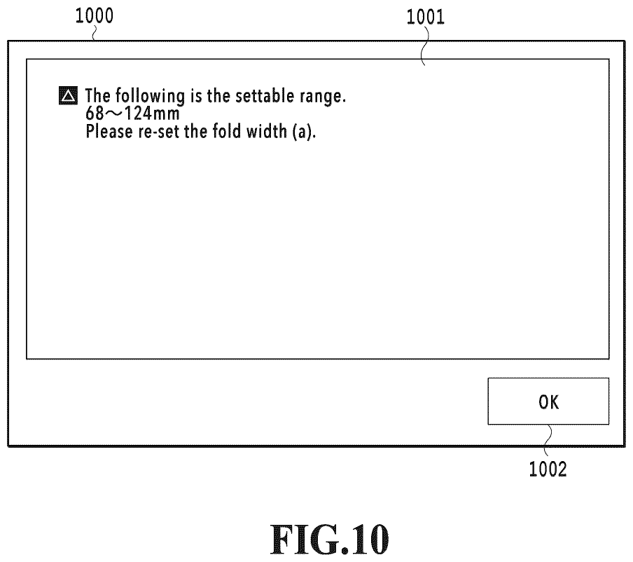

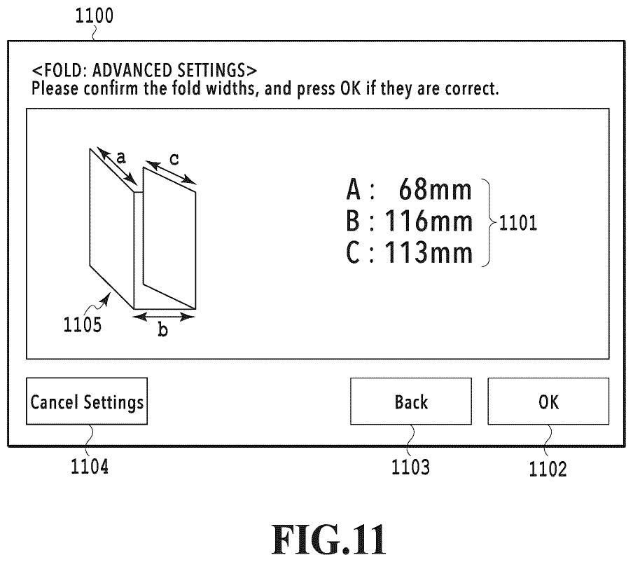

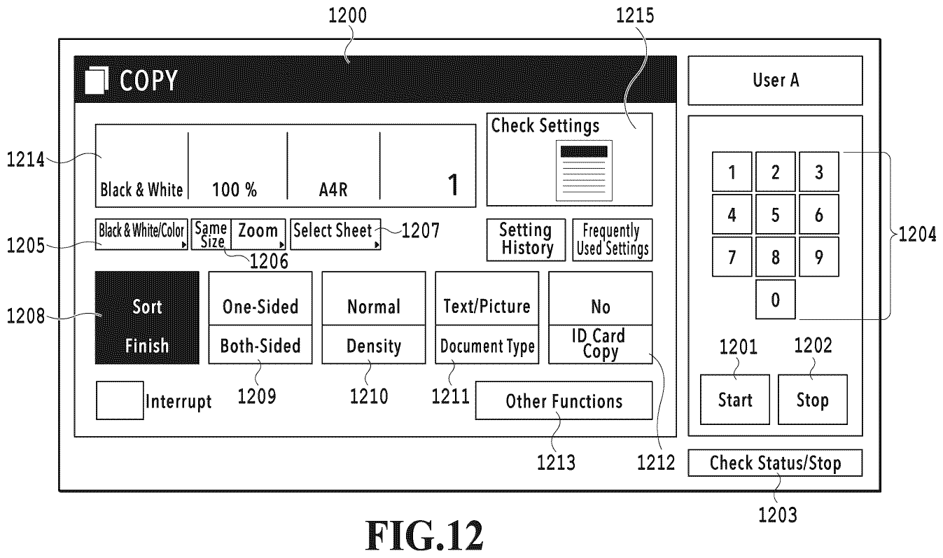

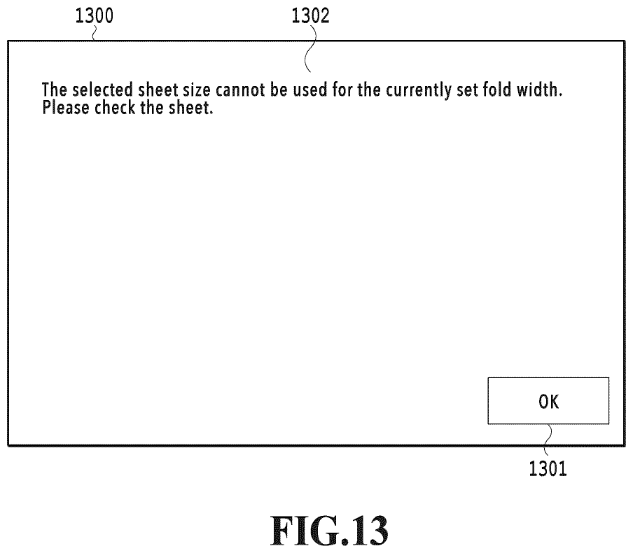

The display control unit 450 causes the operation unit 150 to display screens and information for inputting numerical values and instructions in the process of setting the folding positions. For example, displayed are the finishing screen 300 in FIG. 3, the advanced C-fold setting screen 600 in FIGS. 6A and 6B, the fold width acceptance screen 800 in FIG. 8, the sheet selection screen 900 in FIG. 9, the error screen 1000 and 1300 in FIGS. 10 and 13, the fold width confirmation screen 1100 in FIG. 11, the copy screen 1200 in FIG. 12, and so on. The contents displayed in each screen will be described later.

The post-processing control unit 460 controls the folding mechanism of the finisher 160 so as to perform a folding process at the folding positions set by the folding position determination (setting) unit 440. Specifically, for C-fold, the post-processing control unit 460 moves the positions of the stoppers 285 and 290 of the CZ-folding process unit 280.

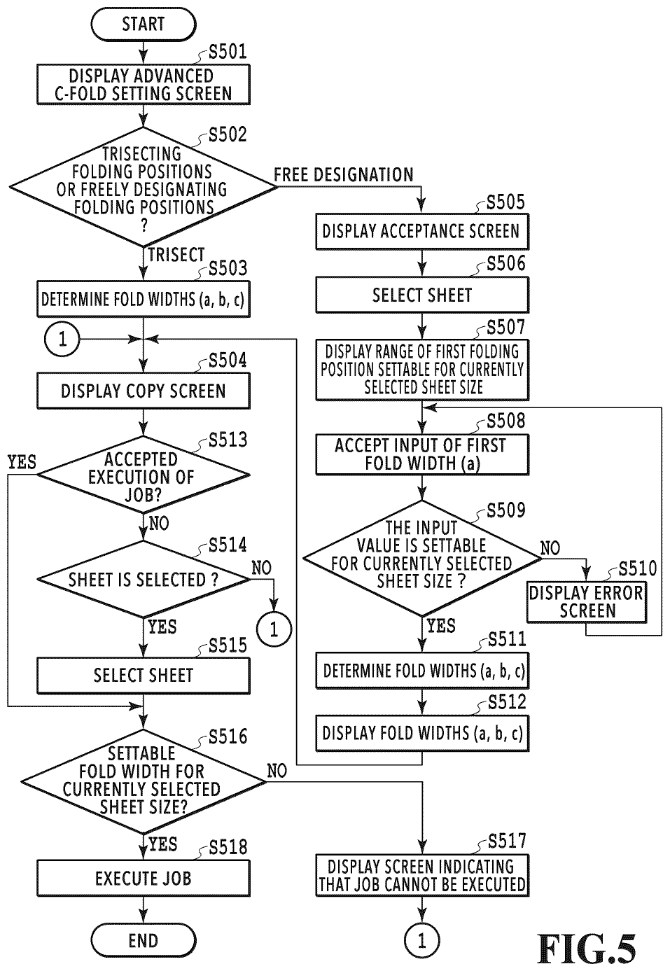

Next, a flow of the process of setting the folding positions executed by the CPU 111 will be described with reference to FIG. 5. The control unit 110 of the MFP 100 calls a program stored in the SSD 114 or the ROM 113 and loads the program to the RAM 112 and the CPU 111 executes the program to implement the process illustrated in the flowchart. Each symbol “S” in the following description means a step.

The process in the flowchart starts in a case where the “C-fold” button 309 in the above finishing screen 300 (FIG. 3) is operated. C-fold refers to a process of valley-folding (or mountain-folding) a sheet(s) at each of two folding positions that are parallel to each other.

In step S501, the CPU 111 displays the advanced C-fold setting screen 600 on the operation unit 150 and accepts advanced settings of C-fold by the user.

FIG. 6 is a diagram illustrating an example of the advanced C-fold setting screen 600. As illustrated in FIG. 6, the advanced C-fold setting screen 600 includes a numerical value input area 601 to input the number of sheets to be folded in an overlapping manner, a “plus-minus” button 602, and fold width selection buttons (a “trisect” button 606 and a “designate” button 607). The C-fold detail setting screen 600 also includes a “cancel settings” button 603, a “back” button 604, an “OK” button 605, and so on.

A numerical value can be input into the numerical value input area 601 with the “plus-minus” button 602. Alternatively, the numeric keypad of the operation unit 150 or a numeric keypad button group 1204 in the copy screen 1200 illustrated in FIG. 12 may be utilized to input a numerical value. In the present embodiment, the maximum number of sheets to be folded in an overlapping manner is five. The CPU 111 controls the inputtable numbers to 1 to 5.

The fold width selection buttons 606 and 607 are buttons that accept a choice about whether to determine the fold widths automatically or manually (to freely designate the fold widths). In a case where the “trisect” button 606 is operated, the folding process will be performed at two preset folding positions that divide the sheet size into three substantially equal parts. In a case where the “designate” button 607 is operated, the folding process will be performed with any position designated by the user as the first folding position.

In S502, the CPU 111 determines whether the “trisect” button 606 selected or the “designate” button 607 is selected. In a case where the “OK” button 605 is operated with the “trisect” button 606 selected as illustrated in FIG. 6A, the CPU 111 closes the advanced C-fold setting screen 600 and proceeds to S503. In a case where a “next” button 608 is operated with the “designate” button 607 selected as illustrated in FIG. 6B, the CPU 111 closes the advanced C-fold setting screen 600 and proceeds to S505, in which the CPU 111 displays the folding position setting screen 800.

In a case where the “cancel settings” button 603 in the advanced C-fold setting screen 600 is pressed, the CPU 111 cancels the inputs in the screen 600 and returns to the finishing screen 300. The CPU 111 also returns to the finishing screen 300 in a case where the “back” button 604 is operated.

In S503, the CPU 111 determines the fold widths (a, b, c) of the three panels A, B, and C to be formed on the sheet(s) by the C-folding process. FIG. 7A is diagram explaining the panels A, B, and C formed by on a C-folded sheet. The fold widths of the panels A, B, and C are denoted as a, b, and c, respectively. The difference between the fold widths of the panels B and C (b-c) is the constraint value d.

The constraint value d is determined by a limitation from the hardware of the folding mechanism of the finisher 160 and a constraint from the sheet thickness. Depending on the number of sheets to be stacked, the sheet material, and the like, the sheets can be thick. In that case, it is necessary to leave a margin to prevent the panel C from being caught at the folding position between the panels A and B. In the present embodiment, the constraint value d is exemplarily 3 [mm] but may be 3 [mm] or more or 3 [mm] or less.

In S503, the CPU 111 determines the fold widths (a, b, c) according to the table 720 illustrated in FIG. 7B. As a result, the two folding positions F1 and F2 of the C-fold are determined. The table 720 is stored in the ROM 113 or the SSD 114. The fold widths (a, b, c) defined in FIG. 7B include the constraint value d (=3 [mm]). The CPU 111 may obtain the data of the table 720 through the network I/F 115 and hold them in the RAM 112.

The table 720 illustrated in FIG. 7B represents a specific example of the sheet sizes with which a C-fold can be made with the finisher 160 (CZ-folding unit 161) and the fold widths (a, b, c) of the panels A, B, and C for each of those sheet sizes. In this example, A4R, LTRR, B4, LGL, and A3 are registered as the C-foldable sheet sizes in the table 720. For each sheet size, the fold widths (a, b, c) are each set to be substantially equal to ⅓ of an entire length X of each long side with the constraint value d illustrated in FIG. 7A taken into account.

After determining the fold widths in S503, the CPU 111 closes the advanced C-fold setting screen 600 and proceeds to S504.

In S504, the CPU 111 waits for the user's operation to execute a job. For example, the CPU 111 displays the copy screen 1200 illustrated in FIG. 12 and waits for an operation on a “start” button 1201. The process in S504 will be described later.

Next, the case where the “designate” button 607 is selected as illustrated in FIG. 6B will be described.

In S505, the CPU 111 displays the acceptance screen 800.

FIG. 8 is a diagram illustrating an example of the acceptance screen 800. The acceptance screen 800 includes a sheet size display area 801, a sheet size change button 802, a fold width input field 806, a plus button 805, a minus button 804, a “cancel settings” button 807, a “back” button 808, and an “OK” button 809. Moreover, an operation guidance message such as “Please select the sheet type to be used, and enter the fold width (a).”

The sheet size display area 801 displays the currently selected sheet size. The sheet size can be changed on the sheet selection screen 900, which can be reached by operating the sheet size change button 802.

FIG. 9 is a diagram illustrating an example of the sheet selection screen 900.

As illustrated in FIG. 9, the sheet selection screen 900 includes a selected sheet display area 903 indicating the currently selected sheet, a sheet selection button group 901, an “OK” button 902, and so on. The sheet selection button group 901 displays buttons corresponding to the sheet cassettes 217 of the MFP 100 which can feed sheets among the sheets selectable for C-fold. In the example of FIG. 9, the manual feed tray, an A4R tray, and an A3 tray are displayed.

In S506, a sheet is selected and the “OK” button 902 is operated. In response to this, the CPU 111 sets the selected sheet as the currently selected sheet, and returns to the acceptance screen 800.

In S507, the CPU 111 displays a range of the first folding position, i.e., a range of the fold width (a), that is settable for the currently selected sheet size in a range display field 803. For example, as illustrated in FIG. 8, in a case where A4R is selected as the sheet size, the CPU 111 displays “68-124” [mm] as the range of the fold width (a) settable for A4R in the range display field 803 near the fold width input field 806. The CPU 111 refers to the table 730 illustrated in FIG. 7C, obtains the upper limit value and the lower limit value for “a” associated with the currently selected sheet size, and displays them in the range display field 803.

The table 730 is stored in the SSD 114 or the ROM 113 in advance. Alternatively, the CPU 111 may obtain the data of the table 730 through the network I/F 115 and hold them in the RAM 112.

The acceptance screen 800 also displays a schematic diagram 810 illustrating a C-folded sheet. In the schematic diagram 810, the positions of the fold widths (a, b, c) on the sheet are indicated. By referring the schematic diagram 810, the user can visually confirm to which panel's length the fold width (a) to be input into the input field 806 corresponds.

In S508, the CPU 111 accepts input of the value of the fold width (a) of the panel A into the fold width input field 806. The fold width (a) of the panel A is the distance from an end of the sheet to the first folding position. In a case where the user operates the “plus” button 805 and the “minus” button 804, the value in the fold width input field 806 changes, and the resulting fold width (a) of the panel A is input into the fold width input field 806. Incidentally, the numeric keypad of the operation unit 150 or the numeric keypad button group 1204 in the copy screen 1200 illustrated in FIG. 12 may be utilized to perform the operation of inputting a value into the fold width input field 806.

In a case where the “cancel settings” button 807 in the acceptance screen 800 is operated, the CPU 111 cancels all settings in the acceptance screen 800. In a case where the “back” button 808 is operated, the CPU 111 returns to the previous screen (advanced C-fold setting screen 600). In a case where the “OK” button 809 is operated, the CPU 111 proceeds to S509.

In S509, the CPU 111 determines whether the value input in S508 is in the range settable as the fold width (a) of the panel A. Specifically, the CPU 111 refers to the table 730 illustrated in FIG. 7C and obtains the upper limit value and the lower limit value for “a” associated with the currently selected sheet size. The CPU 111 proceeds to S511 in a case where determining that the value input in S508 is a value in the range defined by the obtained upper limit value and lower limit value. The CPU 111 proceeds to S510 in a case where determining that the value input in S508 is not a value in the range defined by the obtained upper limit value and lower limit value.

In S510, the CPU 111 displays the error screen 1000.

FIG. 10 is a diagram illustrating an example of the error screen 1000. As illustrated in FIG. 10, the error screen 1000 includes a message display area 1001 and an “OK” button 1002. The message display area 1001 displays a message that prompts re-setting of the value, the values of the right setting range, and so on. In a case where the “OK” button 1002 is operated, the CPU 111 returns to S508 and accepts input of a value into the fold width input field 806.

In S511, the CPU 111 determines the fold widths (a, b, c). In S511, the CPU 111 calculates the fold widths (b) and (c) of the panels B and C such that a value derived by subtracting the fold width (a) (first folding position) input in S508 from the entire length X of each long side of the sheet(s) is approximately half of the entire length X. At this time, the CPU 111 determines the fold widths (a, b, c) with the constraint value d in FIG. 7A taken into account. As a result, the second folding position is determined. Specifically, the fold widths (a, b, c) are determined from the following equations.

$$\begin{matrix}a = I \\ b = d + ( X - a ) / 2 \\ c = X - a - b\end{matrix}$$

In S512, the CPU 111 displays the fold width confirmation screen 1100.

FIG. 11 is a diagram illustrating an example of the fold width confirmation screen 1100. As illustrated in FIG. 11, the fold width confirmation screen 1100 includes a fold width display area 1101, an “OK” button 1102, a “back” button 1103, and a “cancel settings” button 1104.

The fold width confirmation screen 1100 displays a schematic diagram 1105 illustrating a sheet after the folding process. In the schematic diagram 1105, the positions of the fold width of each panel (a, b, c) is indicated. In the example of FIG. 11, “A: 68 mm, B: 116 mm, C: 113 mm” is displayed in the fold width display area 1101. By referring to the fold width display area 1101 along with the schematic diagram 1105, the user can visually confirm to which panel's length each of the fold widths (a, b, c) corresponds.

In a case where the “cancel settings” button 1104 in the fold width confirmation screen 1100 is operated, the fold widths determined in S511 are canceled. In a case where the “back” button 1103 is operated, the CPU 111 returns to the previous screen (acceptance screen 800). In a case where the “OK” button 1102 is operated, the CPU 111 completes the setting of the fold widths and proceeds to S504.

In S504, the CPU 111, for example, displays the copy screen 1200 and waits for execution of a job. FIG. 12 is a diagram illustrating an example of the copy screen 1200. As illustrated in FIG. 12, the copy screen 1200 includes the “start” button 1201 for issuing an instruction to start a copy job, a “stop” button 1202 for issuing an instruction to stop a copy job, and the numeric keypad button group 1204 for inputting numerical values such as the number of copies to be made. The copy screen 1200 also includes buttons 1205 to 1213 to be operated to accept settings for selecting monochrome or color copying, selecting the magnification, selecting the sheet, selecting the finishing process, selecting double-side printing or one-side printing, setting the density, selecting the document type, selecting whether an ID card is to be copied, selecting functions, and so on.

A display area 1214 displays print setting information such as the monochrome/color setting, the magnification, the sheet, and the number of copies to be made set by using the group of function buttons 1205 to 1213. A setting confirmation area 1215 is a button to be operated to transition to a preview screen (not illustrated).

In S513, the CPU 111 determines whether it has accepted execution of a job. In a case where the “start” button 1201 in the copy screen 1200 is operated, the CPU 111 determines in S513 that it has accepted execution of a job, and proceeds to S516. In a case where the “start” button 1201 is not operated in S513, the CPU 111 proceeds to S514.

Incidentally, in the present embodiment, an example in which the CPU 111 accepts an instruction to execute a job via an operation on the “start” button 1201 in the copy screen 1200 has been described. However, the present embodiment is not limited to this example. The CPU 111 may accept an operation as an instruction to execute a job from a screen other than the copy screen by, for example, reading out and outputting (printing out) data held in a storage area in the MFP 100 via an operation on the operation unit 150.

In S514, in a case where a “select sheet” button 1207 is operated, the CPU 111 proceeds to S515. In a case where the “select sheet” button 1207 is not operated in S514, the CPU 111 returns to S504.

In S515, the CPU 111 displays the sheet selection screen 900 illustrated in FIG. 9 and accepts changing of the sheet size.

In S516, the CPU 111 determines whether the fold widths (a, b, c) determined in S503 or S511 are settable fold widths for the currently selected sheet size.

For example, in a case where the sheet size has been changed to LTRR in S515 while the fold width (a) of the panel A has been set to 124 mm with A4R selected in S506, the CPU 111 determines that the fold widths (a, b, c) are in a range in which LTRR is settable. As illustrated in the table 730 illustrated in FIG. 7C, the range of the fold width (a) in which LTRR is settable is defined to be 68.0 [mm] to 106.0 [mm]. Thus, the fold width (a) is determined to be outside the range.

In a case where determining in S516 that any one of the fold width (a, b, c) is not settable for the currently selected sheet size, the CPU 111 proceeds to S517. In a case where determining that all of the fold widths (a, b, c) are settable for the currently selected sheet size, the CPU 111 proceeds to S518.

In S517, the CPU 111 displays the error screen 1300. As illustrated in FIG. 13, the error screen 1300 displays a message display area 1302 and an OK button 1301. The message display area 1302 displays a message indicating that a C-fold cannot be made with the sheet size and fold width that are currently set. In a case the “OK” button 1301 is operated, the CPU 111 closes the error screen 1300, returns to S504, and transitions to the copy screen 1200.

In S518, the CPU 111 executes the job. Specifically, the CPU 111 sends image data to the printer 140 and executes a print process based on the print setting information. Also, the CPU 111 controls the folding mechanism of the finisher 160 based on the information set on the advanced setting screen 600 for the folding process illustrated in FIG. 6 to execute the folding process on the printed sheet(s). As a result, the sheet(s) subjected to the printing and the folding process is (are) discharged, and the process of the flowchart illustrated in FIG. 5 is terminated.

Note that whether to fold the sheet(s) first at the folding position F1 or at the folding position F2 varies depending on the structure of the folding process unit. Moreover, the fold widths and the stopper positions also vary depending on the structure. Furthermore, the sheet conveyance paths also vary depending on the apparatus structure. The CPU 111 executes print control, conveyance control, and folding process control that are suitable for the apparatus structure.

It is also possible to, for example, use the folding mechanism of the finishing unit 162 (such as the folding roller pair 236, the pushing member 251, and the positioning member 250) so as to perform a folding process twice to make a C-fold shape. In that case, each sheet fed from the sheet feed port 228 is conveyed to the conveyance path 237 and undergoes a switchback operation. Thereafter, the sheet is conveyed to the stacking unit 235 to become a stack of sheets including the number of sheets to be folded in an overlapping manner.

In the first folding operation in C-folding, the positioning member 250 is moved such that the first folding position F1 on the stack of sheets conveyed to the stacking unit 235 faces the folding rollers 236. The finishing unit 162 causes the pushing member 251 to project in the direction of the arrow to fold the stack of sheets at the first folding position F1 with the folding rollers 236. Then, the finishing unit 162 brings the stack of sheets back to the stacking unit 235.

After bringing the stack of sheets back to the stacking unit 235, the finishing unit 162 performs the second folding operation. In the second folding operation, the finishing unit 162 moves the positioning member 250 such that the second folding position F2 on the stack of sheets faces the folding rollers 236. The finishing unit 162 causes the pushing member 251 to project in the direction of the arrow to fold the stack of sheets at the second folding position F2 with the folding rollers 236. The stack of sheets thus C-folded by the two folding operations is conveyed to the conveyance path 240. The printed sheets are discharged in the C-folded shape onto the booklet tray 242.

Incidentally, the CPU 111 of the MFP 100 controls the positions at which the positioning member 250 is stopped in the folding operations (the amounts of movement of the positioning member 250). The CPU 111 drives the positioning member 250, the pushing member 251, and the folding rollers 236 by controlling driving motors provided individually for the positioning member 250, the pushing member 251, and the folding rollers 236.

As described above, for the folding positions for C-fold, the MFP 100 according to the present embodiment can provide a choice as to whether to set the preset positions with which the sheet length is substantially equally divided into three parts or to accept free designation by the user. In this way, the user can easily make a choice between C-fold for a prescribed envelope size and C-fold with the fold widths designated by the user themself. Since the fold widths can be freely set, folds can be made at any folding positions that are not limited by the envelope size. Accordingly, the MFP 100 can be used in a wide variety of applications.

Also, in the case where free designation is selected, a range of designatable numerical values corresponding to the currently selected sheet size is displayed on the operation unit 150. In addition, which position's value to input is displayed in a schematic diagram. Accordingly, the user can intuitively perform an operation to set the fold widths.

Moreover, before inputting a job, the CPU 111 determines whether the numerical value input in the fold width input field 806 is an invalid value for the currently selected sheet size, and prompts re-setting of the numerical value by displaying the error screen 1000 in a case where the input numerical value is an invalid value for the sheet size. Also, after inputting the job, the CPU 111 determines whether an invalid fold width is set for the sheet size, and issues a warning by displaying the error screen 1300 in a case where an invalid fold width is set. This prevents a wrong numerical value from being input and prevents an unintended product from being made. Accordingly, the present disclosure improves usability in setting the folding positions.

Note that in the above embodiment, free designation of the fold widths in C-fold (inside tri-fold) has been described. However, the present disclosure is not limited to C-fold and is applicable to folding processes such as Z-fold (outside tri-fold), half C-fold, and quarter fold. Z-fold (outside tri-fold) is a tri-folding process in which a valley fold is made at the first folding position and a mountain fold is made at the second folding position. Half C-fold is a folding process in which a sheet(s) is (are) folded at the middle of the long sides and then subjected to first folding and second folding in a perpendicular direction. Quarter fold is a process in which a sheet(s) is (are) folded (valley-folded) in half at the first folding position, and the sheet(s) folded in half is (are) folded (valley-folded) in half at the second folding position.

The CPU 111 of the MFP 100 accepts selection of automatic setting of the folding positions or manual setting (free designation) of the folding positions for Z-fold (outside tri-fold), half C-fold, and quarter fold as well. In a case where the manual setting (free designation) is selected and the user designates the fold width from an end of the sheet(s) to the first folding position, the CPU 111 determines the second folding position such that the folding process will be performed properly, and controls the folding process at each folding position.

For Z-fold, half C-fold, and quarter fold too, tables for automatic folding in which fold widths corresponding to sheet sizes are defined, tables for free designation in which ranges of the fold widths (upper limit values and lower limit values) corresponding to sheet sizes are defined are stored in the RAM 112 or the SSD 114.

Also, in the above embodiment, an example has been presented in which, in the case of determining the fold widths (a, b, c), the fold widths (b) and (c) or the panels B and C are each calculated such that the value derived by subtracting the fold width (a) of the panel A (first folding position) and the constraint value d from the entire length X of each long side of the sheet(s) is approximately half. However, this calculation method is an example, and the fold widths (b) and (c) may be determined by another method. For example, the second folding position may be determined such that the fold widths (b) and (c) of the panels B and C are in a predetermined ratio such as 2:1 or 3:1.

Also, a configuration that accepts designation of not only the first folding position but also the second folding position may be employed. In this case, the acceptance screen 800 is provided with an input field for the fold width (a) and an input field for the fold width (b) or (c). The CPU 111 accepts designation of the fold widths (a, b, c) within the upper limit values and the lower limit values of these fold widths illustrated in the table 730 of FIG. 7C, and determines the two folding positions based on the input values and the sheet size. In this way, the MFP 100 can be used in various applications not limited to applications involving enclosing a printed product in an envelope (e.g., processing a sheet with any design).

Also, in the above embodiment, an example in which the control unit 110 of the MFP 100 controls the settings and operation of the finisher 160 has been presented, but the present disclosure is not limited to this example. The configuration may be such that a control unit provided inside the finisher 160 (the finisher's CPU) controls the settings and the processes in the present disclosure. Alternatively, the configuration may be such that a computer such as the PC 170 directly controls the finisher 160 to configure the settings and execute the processes in the present disclosure.

### Other Embodiments

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to exemplary embodiments, it is to be understood that the disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2023-093891, filed Jun. 7, 2023, which is hereby incorporated by reference wherein in its entirety.

What is claimed is:

1. A control apparatus comprising:
one or more memories; and
one or more processors functioning by executing instructions stored in the one or more memories as the following units:
an acceptance unit configured to accept a length from an end of a sheet to a first folding position; and
a first setting unit configured to set a second folding position different from the first folding position on the sheet based on a length of the sheet and the length accepted by the acceptance unit.

2. The control apparatus according to claim 1, wherein the length of the sheet is a length of a long side of the sheet.

3. The control apparatus according to claim 1, wherein the one or more processors are further configured to function as: a first display control unit configured to perform control to display a range of the first folding position that is settable for a size of the sheet.

4. The control apparatus according to claim 3, wherein the first display control unit further performs control to display a schematic diagram illustrating the sheet subjected to a folding process, and performs control to display the first folding position in the schematic diagram.

5. The control apparatus according to claim 1, wherein the one or more processors are further configured to function as: a selection acceptance unit having the first setting unit and a second setting unit configured to automatically set the first folding position and the second folding position, and configured to accept a choice about whether to use the first setting unit or to use the second setting unit.

6. The control apparatus according to claim 5, wherein a range of the first folding position that is settable for a size of the sheet is displayed in a case where the first setting unit is selected through the selection acceptance unit.

7. The control apparatus according to claim 5, wherein the one or more processors are further configured to function as: an obtaining unit configured to obtain a first table in which fold widths of panels formed on the sheet by the first folding position and the second folding position are defined for each of sizes of the sheet, and a second table in which ranges of the fold widths of the panels are defined, wherein
the first folding position and the second folding position are determined based on the first table in a case where the second setting unit is selected through the selection acceptance unit, and the second folding position is determined such that the fold widths of the panels fall within the respective ranges defined in the second table in a case where the first setting unit is selected through the selection acceptance unit.

8. The control apparatus according to claim 1, wherein the one or more processors are further configured to function as: a second display control unit configured to perform control to display the fold widths of the panels on the sheet formed based on the first folding position accepted by the acceptance unit and the second folding position set by the first setting unit.

9. The control apparatus according to claim 1, wherein the one or more processors are further configured to function as: a first error notification unit configured to notify of an error in a case where a value of the first folding position accepted by the acceptance unit is determined to be not in a range that is settable for a size of the sheet.

10. The control apparatus according to claim 1, wherein the one or more processors are further configured to function as: a second error notification unit configured to notify of an error in a case where a value of the second folding position set by the first setting unit is determined to be not in a range that is settable for a size of the sheet.

11. The control apparatus according to claim 1, wherein the control apparatus controls a tri-folding process so as to form the first folding position and the second folding position on the sheet.

12. A method of controlling an image processing apparatus, the method comprising:
accepting a length from an end of a sheet to a first folding position; and
setting a second folding position different from the first folding position on the sheet based on a length of the sheet and the length accepted in the accepting.

13. A non-transitory computer readable storage medium storing a program which causes a computer to execute a method of controlling an image processing apparatus, the method comprising:
accepting a length from an end of a sheet to a first folding position; and
setting a second folding position different from the first folding position on the sheet based on a length of the sheet and the length accepted in the accepting.
